(19) United States
(12) Patent Application Publication
(10) Pub. No.: US 2011/0193884 A1
(43) Pub. Date: Aug. 11, 2011

(54) Set Color Level According To Origin

(76) Inventor: Victor Lee, Sunnyvale, CA (US)

(21) Appl. No.: 12/703,031

(22) Filed: Feb. 9, 2010

(51) Int. Cl. G09G 5/10

(52) U.S. Cl. 345/690

(57) ABSTRACT

In one embodiment a system includes a source. The source can include a source port to transmit video data from the source. The source port can also receive origin data from a display device. The source can include a controller to compare an origin of the display device to an origin in the source and set the color levels for the video data based on the origin.

### BACKGROUND

The High definition multimedia interface (HDMI) specification differentiates between consumer electronics and personal computers. The ratio of length to height of a display is different depending on weather the display is a consumer electronics display such as a television or a personal computer display such as a monitor. The consumer electronics displays may have a ratio of 16×9 and the personal computer displays may have a ratio of 16×10. High definition video content is in the 16×9 ratio for consumer electronics as most high definition videos are watched on the television. There is also a difference between the color signal levels. A consumer electronics display can have a color range from black to white that is narrower than the personal computer color scale for RGB (Red, Green, Blue). For example the consumer electronics display can have a scale of 16-235 with 16 being black and 235 being white and the personal computer display can have a scale of 0-255 with 0 being black and 255 being white.

### BRIEF DESCRIPTION OF THE DRAWINGS

Some embodiments of the invention are described with respect to the following figures:

FIG. 1 is a block diagram according to an example embodiment of the invention;

FIG. 2 is a block diagram according to an example embodiment of the invention;

FIG. 3 is a block diagram according to an example embodiment of the invention; and

FIG. 4 is a flow diagram according to an example embodiment of a method of the invention.

### DETAILED DESCRIPTION

A source device, for example a computing device or video player, may include an HDMI port to transmit video data to a display. A video player may be for example a DVD, or Blu-Ray® player. The digital data that makes up a digital image may be processed by the general purpose processor, the graphics processor and a processor on the display itself before an image is visible to a user. Displays have different specifications and the same digital data on one display may appear different to a user than the digital data on another display. Setting the source to the correct specifications of the display may determine the accuracy of the display's representation of the digital data. To determine the specifications for the display, the source may request that the display retrieve the Extended display identification data (EDID) in the display. The information from that EDID may include the resolution of the display. For example the EDID may indicate to the source that the resolution of the display is 1920×1080 pixels. The EDID may also indicate for example the refresh rate, color information, the manufacturer, the model number or other information, however in one embodiment the EDID may not include information that could be included in the EDID, for example the color information. The source can determine that the ratio of the length to the width of the display is 16×9. The source can determine from the ratio whether the display is a consumer electronics or personal computer display. If the ratio of the display is determined by the source to be a consumer electronics display then the source may use settings for the display that correspond to the consumer electronics, for example the color level scales corresponding to a consumer electronics display even though the monitor is a person computer display.

The source may adjust settings such as the color level scale based on its determination of whether the display is a consumer electronics or personal computer display. Computers can be used for displaying video content and the personal computer displays now use the consumer electronics 16×9 length to height the ratio to show the video on the complete display. However the personal computer displays do not use the other settings of the consumer electronics display is such as the color level scale. A personal computer display with a 16×9 ratio may still expect to receive colors on the range of 0-255.

If a source outputs video with a color level scale of 16-235 to a personal computer display expecting a signal on the color level scale of 0-255, a personal computer outputting black at level 16 would be displayed by the display as gray. The result is a display that is to receive personal computer signals may not display a black or a white color because the signal received by the computer does not include the upper and lower ranges of the scale for a personal computer.

Computers can be used for graphic designs, video editing, and picture editing among other uses and the more color levels in the scale the better the image on the display is going to represent the digital image. A display may be set to receive the color levels on the scale according to the origin of the display if information regarding the color level scale is not available. For example if the display is a 16×9 ratio, the display can be set to receive colors on the scale from 0-255 if the origin of the display and the source are compatible. In one embodiment, the source can be paired so that a source from the same manufacturer as the display automatically sets a color level scale of 0-255 and if the source is connected to a display of another manufacturer the source can adjust the color level scale according to the resolution of the display.

In one embodiment a system includes a source. The source can include a source port to transmit video data from the source. The source port can also receive origin data from a display device. The source can include a controller to compare an origin of the display device to an origin in the source and set the color levels for the video data based on the origin.

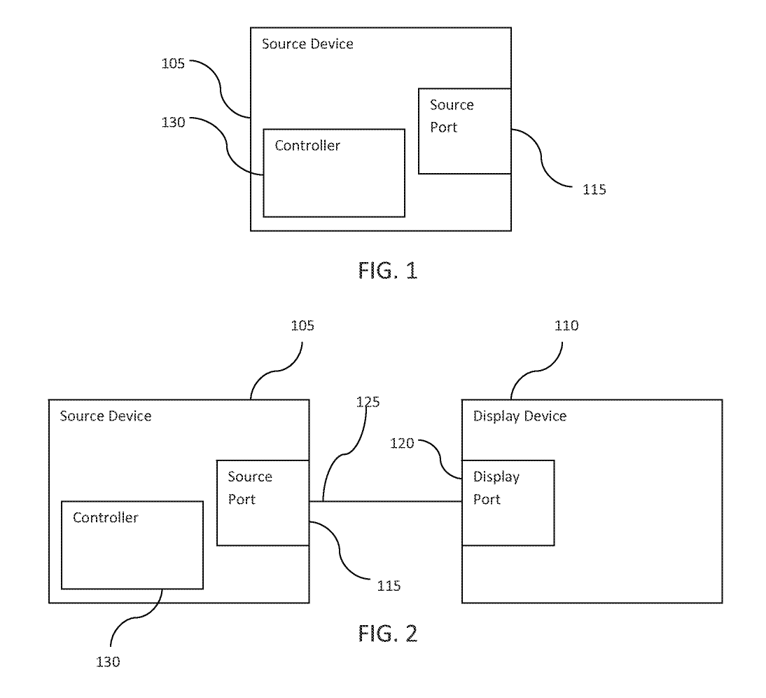

With reference to the figures, FIG. 1 is a block diagram according to an example embodiment of the invention. The system can include a source 105. The source 105 can include a source port 115 to transmit video data from the source and to receive origin data from a display device. The source port 115 can be for example an HDMI port or may be another type of port to transmit data to a display device. The source port 115 may be a wired or wireless port.

The source 105 can include a controller 130 in the source 105 to compare an origin of a display device connected to the source port 115 to an origin in the source 105. The controller can adjust the color levels of based on the comparison of the origin of the display device and the origin of the source 115. The origin may be for example the manufacturer. If the origin of the source 105 and the origin data received by the display device correspond then the controller can set the color level scale to a scale that is used if the origin of the source 105 and the origin data correspond. For example if the source and the display device are of the same manufacturer the color level scale can be set to 0-255. In one embodiment the color level can be set according to the origin even if the resolution corresponds to a color level scale that is different than the color level scale that is set by the source if the manufacturer corresponds to the display device manufacturer.

FIG. 2 is a block diagram according to an example embodiment of the invention. The system includes a source device 105 and a display device. The source device 105 can include a source port 115. The display device can include a display port. The source port and the display port 120 may be connected wirelessly or the ports may be connected by a cable 125. If the source port is connected to the display port with a cable the cable may be an HDMI cable for example. In one embodiment the cable 125 can transfer data between the source and the display device. The data may be video data, audio data or may be other data such as identification data or EDID data.

In some embodiments the display port 120 may have the physical dimensions of an HDMI port but may perform electronically according to a DVI port. DVI is a personal computer standard for displays that are used with computers. If a display device 110 follows the DVI specifications the display port 120 is configured to receive RGB color levels on a scale of 0-255 and is not dependent on the resolution of the display. For example the if the display device 110 has a screen resolution ratio of 16×9 then and the display follows the DVI specification the display port 120 is configured to receive RGB color levels on the scale of 0-255 but if the display follows the HDMI specification and the display device 110 has a screen resolution ratio of 16×9 then the display port 120 is configured to receive RGB color levels on the scale of 16-235.

The source device 105 can be for example a computing device. A computing device may be for example a desktop computer, a portable computer, a personal digital assistant, phone or another computing device. The source device 105 can include a controller 130. The controller 130 can determine the origin of the display device 110. The origin may be for example the manufacturer of the display device. In one embodiment the controller 130 polls the display device 110 which returns the information to the controller 130. In one embodiment the display 110 sends information about the display device 110 automatically once the display device 110 is connected to a source device 105.

The controller can be used to configure the data that will be transmitted by the source port 115 to the display device 110. In one embodiment the controller can determine which color scale is used. If the controller 130 determines that the display device 110 and the source device 105 are from the same origin, the controller 130 sets the output color level scale for the video to be output from the source port 115 to the computer color level scale of 0-255 independent of the resolution of the display device 110.

In one embodiment the controller can set the color level scale according to the resolution of the display device if the display device 110 and the source device 105 are not from the same origin. For example if the display device 110 and the source 105 are not from the same origin and the display device 110 has a resolution ratio of 16×9 the controller 130 can set the color level scale to 16-235 or if the display device 110 has a resolution ratio of 16×10 the controller 130 can set the color level scale to 0-255. If the controller sets the color level scale to a scale that has more levels than would be used by a display with a 16×9 resolution ratio based on the origin of the display device 110 and the source 105 then a display device 110 and a source device 105 from the same origin would have better image quality than if the scale was based on the resolution ratio. For example, if the display device 110 with a 16×9 resolution ratio and the source 105 operated on the same color level scale they would be on the 16-235 consumer electronics color level scale that includes 220 levels of color and not the 0-255 scale that includes 255 levels of color if the with color level scale was not determined based on the origin. The origin can be for example the manufacturer, distributor, or may be some other information such as the model of the display device 110 and the source 105.

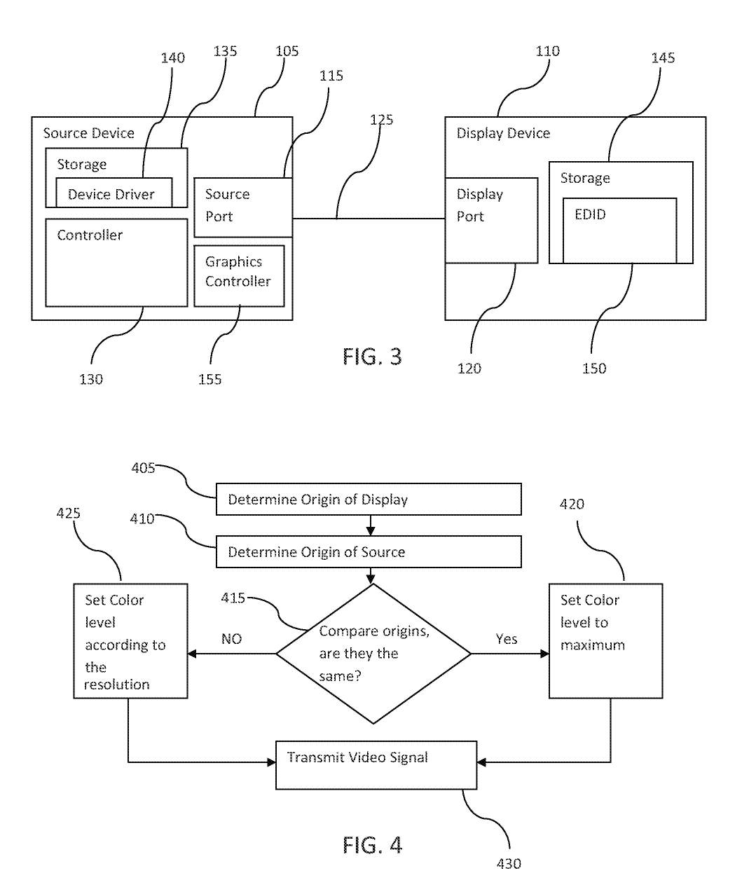

FIG. 3 is a block diagram according to an example embodiment of the invention. The system can include a source device 105 and a display device 110. The display device can include a storage 145 that includes EDID 150. The EDID 150 data can include for example, manufacturer name, serial number, product type, phosphor or filter type, timings supported by the display, display size, luminance data and pixel mapping data however the EDID may not include all of the information that can be included in the EDID. Additionally, the information can be requested separately, for example if the source 105 determines that the display device 110 is from a compatible manufacturer then the source device sets the color level and may not ask the display device 110 for additional information from the EDID. The storage can be for example a solid state memory such as flash memory, Read only memory (ROM), Electronically Erasable Programmable Read only memory (EEPROM) or another type of memory. The EDID 150 information may be requested by a controller 130 on the source device 105. The EDID 150 data can be transmitted to the source device 105 over a serial bus carried by the cable 125 from the display port 120 to the source port 115.

The controller 130 in the source can access the storage 135 and determine from the storage 135 the origin of the source device 105. The origin may be for example the manufacturer name. The controller can compare the manufacturer name in the storage 135 to the manufacturer name in the EDID 150 received from the display device 110. The controller can then set the color level scale to 0-255 if the manufacturer name in the EDID is determined to be a manufacturer that can be compatible with the color scale of 0-255. In one embodiment multiple manufacturers may be stored by the source device and the EDID may indicated to the controller 130 the manufacturer of the display device 110 and the controller may compare the manufacturer of the display to the multiple manufacturers and if the manufacturer of the display device 105 matches one of the multiple manufacturers the controller can set the color level scale to 0-255. For example if the source device determines that a display device from manufacturer 1 and from manufacturer 2 both can operate with a color level scale of 0-255 then the controller can set the color level scale to 0-255 if either manufacturer 1 or manufacturer 2 is determined by the controller.

A device driver 140 can instruct the components of the source device 105 how to communicate with the graphic controller 155. In one embodiment the device driver 140 is set by the controller 130 to a color level scale. In one embodiment the device driver 140 can communicate with an application on the source device and the graphic controller 155. The application can be for example a graphics application or a media player. If the application sends data to the graphics controller 155 the data is interpreted by the device driver set by the controller 130 to a color level scale. The signal that is transmitted by the source port can be generated by the graphics controller 155 in the color level scale that results in an accurate interpretation of the data from the application as an image being displayed by the display device 110. In one embodiment the controller 130 is part of the graphic controller. In an alternative embodiment the graphic controller can be a separate component or part of a component other than the graphics controller. In another embodiment the controller 130 may be a data processor.

FIG. 4 is a flow diagram according to an example embodiment of a method of the invention. The method can begin by determining the origin of the display device at 405. The method may then determine the origin of the source at 410. The determining the origin of the display device at 405 and determining the origin of the source at 410 do not depend on the order of occurrence. Determining the origin of the source may occur before the origin of the display device is determined.

The origin of the display device determined at 405 and the origin of the source at 410 can be compared at 415. The origin can be compared by a controller that determines if the origins are the same. For example if the same manufacturer made both the display device and the source the method continues and the color level is set to the maximum color level scale. The maximum color level scale may be for example 0-255 if the color is an 8 bit RGB color system. A video signal with a color level scale set to the maximum can be transmitted by the source to a display device at 430.

If the controller determines that the origin of the display device and the source are not the same the method continues to set the color level scale according to the resolution of the display. For example the color level scale may be set to a first scale such as 0-255 if the resolution ratio of the display device is 16×10 or may be set to a second scale such as 16-235 if the resolution ratio of the display device is 16×9. A video signal with a color level scale set according to the resolution ratio can be transmitted by the source to a display device at 330.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system comprising:
a source;
a source port to transmit video data from the source and to receive origin data from a display device;
a controller in the source to compare an origin of the display device to an origin in the source and set the color levels for the video data based on the origin.

2. The system of claim 1, wherein the resolution of the display device is determined by the controller and wherein the color level is determined by the controller according to the resolution if the source and the display device are not from the same origin.

3. The system of claim 1, wherein the resolution of the display device is determined by the controller, wherein the controller sets the color level according to the origin of the source and the display device independent of the resolution of the display device.

4. The system of claim 1, further comprising a display storage on the display device to store data about the origin of the display device.

5. The system of claim 1, further comprising a source storage on the source device to store data about the origin of the display device.

6. The system of claim 1, further comprising a storage on the source that stores multiple origins in the source that are compared to the origin data from the display device.

7. The system of claim 1, wherein the source port accepts an HDMI cable and the display port accepts an HDMI cable.

8. The system of claim 1, further comprising storage that stores personal computer color levels and consumer electronics color levels.

9. The system of claim 8, wherein the controller is to access the personal computer color levels if the origin of the source and the display device are the same.

10. The system of claim 8, wherein the controller determines if the resolution of the display device is a personal computer resolution or a consumer electronics resolution.

11. The system of claim 10, wherein the controller is to access the consumer electronics color level if the origin of the source and the display device are not the same and the resolution is a consumer electronics resolution.

12. A color level control method, comprising:
determining a origin of a display device using a controller on a source device;
determining a origin of the source device and comparing the origins;
setting a color level according to the comparison of the origin; and
transmitting a video signal using the color level set.

13. The method of claim 12, further comprising determining the resolution of the display device.

14. The method of claim 13, further comprising accessing consumer electronic color level if the display resolution is a consumer electronic resolution and the origin of the display device and the source device is not the same.

15. The method of claim 12, further comprising accessing a personal computer color level is the origin of the display device and the source device are the same.

16. The method of claim 12, further comprising increasing the number of color levels if the origin of the display device and the source device are the same.

17. A computer readable medium comprising instructions that if executed cause a computer to:
determine the origin of a display device using a controller on the computer;
determine the origin of the computer and compare the origins;
set a color level according to the comparison of the origin; and
transmit a video signal using the color level set.

18. The computer readable medium of claim 17 further comprising instructions to determine the resolution of the display device.

19. The computer readable medium of claim 17 further comprising instructions to further comprising accessing consumer electronic color level if the display resolution is a consumer electronic resolution and the origin of the display device and the source device is not the same.

20. The computer readable medium of claim 17 further comprising instructions to increase the number of color levels if the origin of the display device and the source device are the same.
